(19) United States
(12) Patent Application Publication
(10) Pub. No.: US 2025/0103588 A1
(43) Pub. Date: Mar. 27, 2025

(54) METHOD AND SYSTEM FOR DETERMINING CATEGORIES FOR SEARCH QUERY

(71) Applicant: NAVER CORPORATION, Seongnam-si (KR)

(72) Inventors: Il Hyeon SONG, Seongnam-si (KR); Dae Neung SOHN, Seongnam-si (KR); Jung-Tae LEE, Seongnam-si (KR)

(21) Appl. No.: 18/895,541

(22) Filed: Sep. 25, 2024

(30) Foreign Application Priority Data
Sep. 25, 2023 (KR) 10-2023-0128143

(51) Int. Cl. G06F 16/242; G06F 16/28

(52) U.S. Cl. CPC G06F 16/242; G06F 16/285

(57) ABSTRACT

A method for determining categories for a search query includes obtaining distribution information on each of a plurality of categories of one or more words included in the query; calculating features of the one or more words based on the distribution information on each of the plurality of categories; and calculating, by a classification model, information on at least one category related to the query based on the features of the one or more words and the query.

### CROSS-REFERENCE TO RELATED APPLICATION

The present application claims priority to and the benefit of Korean Patent Application No. 10-2023-0128143, filed on Sep. 25, 2023, in the Korean Intellectual Property Office, the entire disclosure of which is incorporated by reference herein.

### BACKGROUND OF THE INVENTION

### Field of the Invention

The present disclosure relates to a method and a system for determining categories for a search query, and more particularly, to a method and a system, which can calculate category probability by a classification model that is trained based on whether a user selects a search result for the query or category probability for a product name, and the frequency of category appearance of words included in the query, and can adjust the product search ranking based on the calculated category probability, in order to provide product category information for the query.

### Description of Related Art

Recently, various services, such as shopping, games, movies, and music, have been provided online in the Internet or mobile environments. For example, online shopping has the advantage of being capable of selecting and purchasing products without a time restriction to purchase the products and without directly visiting product sales locations, and has been used by many users. Due to the convenience of such online shopping, users who use the online shopping are increasing, and as a result, the number of products and the types of products being sold or handled online are also increasing exponentially.

For example, if a user accesses an online shopping system and inputs a query for searching for a desired product, the user may be provided with product search results including product information related to the corresponding query and access information about where to buy. Because such an online shopping system extracts the search result by simply comparing the query with product data of a product database, it may be difficult to derive the product search result that matches user's intention included in the query.

In order to solve such problems, a technology has been developed to provide the search results in which product categories intended by the user are reflected from an input query by using an artificial intelligence-based classification model. Such a classification model may be trained based on product information selected by the user from the query input by the user and the search result for the query. For example, training on the classification model may be performed based on search log data.

Because the classification model in the related art is trained so that a higher score is given to the product category that is selected by the user among the actual search results, product category-related scores may be well reflected in the search results for frequent input queries. However, product category-related scores may not be properly reflected in the search results for queries with few inputs. Accordingly, it may be desirable to provide a system in which product category-related scores can be accurately calculated and reflected in the search results even for infrequent input queries.

### BRIEF SUMMARY OF THE INVENTION

In order to solve the above-described problems, embodiments of the present disclosure provide a method for determining categories for a search query, a computer program stored in a computer readable recording medium, and a computer readable recording medium and device (system).

The present disclosure may be implemented in various ways including a method, a device (system), and/or a computer program stored in a computer readable storage medium.

According to an embodiment of the present disclosure, a method, performed by at least one processor, for determining categories for a search query includes: obtaining distribution information on each of a plurality of categories of one or more words included in the query; calculating features of the one or more words based on the distribution information on each of the plurality of categories; and calculating, by a classification model, information on at least one category related to the query based on the features of the one or more words and the query.

A computer program stored in a computer readable recording medium may be provided in order for a computer to execute a method for determining categories for a search query according to an embodiment of the present disclosure.

According to an embodiment of the present disclosure, an information processing system includes: a memory; and at least one processor connected to the memory and configured to execute at least one computer readable program included in the memory, wherein the at least one program includes instructions for obtaining distribution information on each of a plurality of categories of one or more words included in a search query, calculating features of the one or more words based on the distribution information on each of the plurality of categories, and calculating, by a classification model, information on at least one category related to the query based on the features of the one or more words and the query.

According to some embodiments of the present disclosure, the classification model may be trained by using a training data set that is generated based on product category distribution of query configuration words calculated based on various pieces of information related to a product search. By calculating the product category probability related to the query by the classification model trained based on such training data, a phenomenon where product category classification having low relevance to the query is reflected in the search result may be minimized, and more accurately calculated product category information may be reflected in the query search result.

According to some embodiments of the present disclosure, even if a search query including words having a low search frequency is received, the query-related product category may be predicted more accurately through the classification model, and thus the search result that matches the user's intention may be provided. Accordingly, user's selectability or click-through rate about the product search result that is provided to the user in response to the query may be improved.

According to some embodiments of the present disclosure, the importance of each word included in the query may be calculated, and a weight value may be applied to the corresponding word or each of feature vectors thereof based on the importance of each word. Because the features of the words to which the weight values are applied may be input to the classification model, more accurate product category probability may be calculated from the classification model.

The effects of the present disclosure are not limited to those mentioned above, and other effects not mentioned may be clearly understood by those skilled in the art to which the present disclosure pertains from the description of the claims.

### BRIEF DESCRIPTION OF THE DRAWINGS

Embodiments of the present disclosure will be described with reference to the accompanying drawings described below, in which similar reference symbols indicate similar elements but without being limited thereto.

FIG. 1 is a diagram illustrating an example of a service that provides a product search result based on a category classification determined in response to a search query according to an embodiment of the present disclosure.

FIG. 2 is a schematic diagram illustrating a configuration that is communicably connected between an information processing system and a plurality of user terminals according to an embodiment of the present disclosure.

FIG. 3 is a block diagram illustrating an internal configuration of a user terminal and an information processing system according to an embodiment of the present disclosure.

FIG. 4 is a block diagram illustrating an internal configuration of a processor of an information processing system according to an embodiment of the present disclosure.

FIG. 5 is a diagram exemplifying a configuration in which a feature calculation unit and a category determination unit calculate category-related scores from a search query according to an embodiment of the present disclosure.

FIG. 6 is a block diagram illustrating an internal configuration of a feature calculation unit according to an embodiment of the present disclosure.

FIG. 7 is a block diagram illustrating an internal configuration of a feature calculation unit according to another embodiment of the present disclosure.

FIG. 8 is a diagram illustrating a training procedure of a classification model according to an embodiment of the present disclosure.

FIG. 9 is a diagram illustrating a procedure of generating category probability training data based on user selection information on the product search result corresponding to a search query according to an embodiment of the present disclosure.

FIG. 10 is a diagram illustrating a procedure of generating category probability training data based on product names according to an embodiment of the present disclosure.

FIG. 11 is a diagram illustrating a procedure of generating category appearance frequency data for each word according to an embodiment of the present disclosure.

FIG. 12 is a diagram illustrating a training procedure of a classification model according to an embodiment of the present disclosure.

FIG. 13 is a flowchart explaining a method for determining categories for a search query according to an embodiment of the present disclosure.

FIG. 14 is a flowchart explaining a training method of a classification model for a search query according to an embodiment of the present disclosure.

### DETAILED DESCRIPTION OF THE INVENTION

Hereinafter, specific contents for carrying out the present disclosure will be described in detail with reference to the accompanying drawings. However, in the following description, detailed descriptions of well-known functions or configurations will be omitted if there is a risk of unnecessarily obscuring the gist of the present disclosure.

In the accompanying drawings, the same reference symbols are given to the same or corresponding components. Additionally, in the following description of the embodiments, repeated descriptions of the same or corresponding components may be omitted. However, even if the description of a specific component is omitted, it is not intended that such a component not be included in a corresponding embodiment.

Advantages and features of the disclosed embodiments and methods for achieving them will become clear by referring to the embodiments described below in conjunction with the accompanying drawings. However, the present disclosure is not limited to the embodiments disclosed below and may be implemented in various different forms, and these embodiments are provided only to make the disclosure complete and fully inform those skilled in the art of the scope of the invention.

Terms used in the present specification will be briefly described, and the disclosed embodiments will be described in detail. The terms used in the present specification are selected as being general terms currently widely used as much as possible while considering their functions in the present disclosure, but they may vary depending on the intentions of technicians working in the related fields, precedents, the emergence of new technologies, or the like. Further, there may be terms deliberately selected by the applicants, and in such a case, their meanings will be described in detail in the description of the relevant invention. Accordingly, the terms used in the present disclosure should be defined based on the meanings of the terms, rather than simply the names of the terms, and the overall contents of the present disclosure.

In the present specification, singular expressions include plural expressions, unless the context clearly indicates otherwise. Also, plural expressions include singular expressions, unless the context clearly indicates otherwise. In the entire specification, when a specific part includes a specific component, this means that other components may be further included rather than excluding other components unless expressly stated to the contrary.

Further, the term “module” or “unit” used in the specification refers to software or hardware component, and the “module” or “unit” performs specific roles. However, the “module” or “unit” does not mean to be limited to the software or hardware. A “module” or “unit” may be configured to reside on an addressable storage medium and may be configured to operate one or more processors. Thus, as an example, a “module” or “unit” may include at least one of components such as software components, object-oriented software components, class components and task components, processes, functions, attributes, procedures, subroutines, program code segments, drivers, firmware, microcode, circuits, data, databases, data structures, tables, arrays, or variables. Components and modules or units may be combined into a smaller number of larger ones or may be divided into a larger number of smaller ones, while maintaining the same functionality.

According to an embodiment of the present disclosure, a “module” or “unit” may be implemented with a processor and a memory, and may be implemented with a circuit or circuitry. The term “circuit” or “circuitry” may mean a circuit on hardware, and may also mean a circuit on software. The term “processor” should be interpreted broadly to include a central processing unit (CPU), microprocessor, digital signal processor (DSP), controller, microcontroller, state machine, and the like. In some environments, the “processor” may refer to an application-specific integrated circuit (ASIC), programmable logic device (PLD), field programmable gate array (FPGA), or the like. The “processor” may refer to, for example, a combination of a DSP and a microprocessor, a combination of plural microprocessors, a combination of one or more microprocessors coupled with a DSP core, or a combination of other processing devices. Further, the term “memory” should be interpreted broadly to include any electronic component capable of storing electronic information. The “memory” may refer to various types of processor-readable media such as random access memory (RAM), read-only memory (ROM), non-volatile random access memory (NVRAM), programmable read-only memory (PROM), erasable-programmable read-only memory (EPROM), electrically erasable PROM (EEPROM), flash memory, magnetic or optical data storage, and registers. A memory is said to be in electronic communication with a processor if the processor can read information from the memory and/or write information to the memory. The memory integrated into a processor is in electronic communication with the processor.

In the present disclosure, the term “system” may include at least one of a server device and a cloud device, but is not limited thereto. For example, a system may be composed of one or more server devices. As another example, a system may be composed of one or more cloud devices. As still another example, a system may be configured to operate together with a server device and a cloud device.

Further, the terms, such as “first, second, A, B, (a), and (b),” which are used in embodiments below, are only for the purpose of discriminating one constituent element from another constituent element, but the essence, the order or the sequence of the corresponding constituent elements is not limited by the terms.

Further, in the embodiments below, when it is described that a certain constituent element is “connected,” “coupled,” or “linked” to another constituent element, it should be understood that the constituent element may be directly connected or linked to the other constituent element, or a still another constituent element may be “connected,” “coupled,” or “linked” between the respective constituent elements.

In the present disclosure, “each of a plurality of A” may refer to each of all constituent elements included in the plurality of A, or may refer to each of some constituent elements included in the plurality of A.

Prior to the description of various embodiments of the present disclosure, the terms being used will be described.

In embodiments of the present disclosure, the term “query” may include a text (e.g., word, paragraph, and sentence) which may be input and searched for through a search engine, but is not limited thereto. For example, a query may include a text that is input through an input UI of a search program, such as a web browser, a search application, or a shopping application, or may include a text which may be selected through clicking from a query list that is provided by the search program. As another example, a query is not limited to the text, but may include a text or information that may be extracted from multimedia content, such as an image, a video, a voice, and a sound.

In embodiments of the present disclosure, the term “product category” or “category” may represent a kind, a type, or similar product data that is determined to classify the products. The product category may be subdivided into stages, such as a large category, a medium category, a small and medium category, and a small category, depending on the size of the category to which the products belong. Further, in the product categories, the large category may include one or more medium categories, and the medium category may include one or more small and medium categories or small categories. For example, the term “fashion clothing” that is a large category of clothing products may include medium categories, such as “men's clothing,” “women's clothing,” and the like, and the “women's clothing” that is one of the medium categories may include small and medium categories, such as “one-piece dress,” “knitwear/sweater,” and the like. If it is determined which of the product categories by stages as described above the query for the product search is related to, and if the products that belong to the corresponding product categories by stages are searched for, it may be possible to derive the product search result that is close to the user's intention included in the query.

In embodiments of the present disclosure, the term “classification model” may refer generally to a classifier or a machine learning model that has learned to classify unlabeled information based on the relevance to known labeled data. For example, the classification module may include at least one of various machine learning models or artificial neural network models, such as a language model, a support vector machine (SVM), a maximum entropy model, a conditional random field (CRF) model, a feed-forward neural network (FFNN), a recurrent neural network (RNN), a gated recurrent unit (GRU), a long short-term memory (LSTM), a transform model, a bidirectional encoder representations form transformers (BERT) model, and the like.

In embodiments of the present disclosure, the term “embedding” may refer to a technique to convert a categorical or discrete variable into a continuous vector. Embedding may be used to reduce the dimensions of information and to derive the meaning of the information by converting the categorical variable such as a query into the continuous vector. Further, in the case that a query is expressed as a vector in an embedding vector space, close vectors in the vector space may share similar or related characteristics. For example, a method for embedding the query in the vector space may be implemented through training of the artificial neural network.

In embodiments of the present disclosure, the term “product metadata” may refer to various types of data related to the product. For example, the product metadata may include at least one of a brand, a title (or product name), seller information, shopping mall information, a product model name or product description information, and a product category.

Hereinafter, various embodiments of the present disclosure will be described in detail with reference to the accompanying drawings.

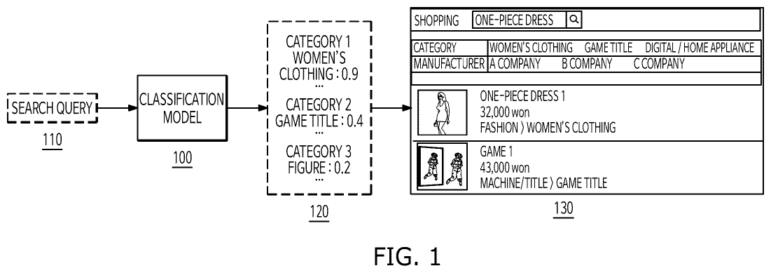

FIG. 1 is a diagram illustrating an example of a service that provides a product search result 130 based on a category classification result (e.g., a probability or score 120) for a search query 110. As exemplified in FIG. 1, the query 110 may be input to the classification model 100, and the probability or score 120 in which the corresponding query is related to each of a plurality of product categories may be calculated. As described above, the calculated probability or score 120 may be reflected in the product search result 130 for the query, and may be output through a user terminal or a display of a computing device to which the query 110 is input.

According to an embodiment, the query 110 or one or more words included in the query 110 may be input to the classification model 100. Here, the classification model 100 may extract input features from the query 110 or the one or more words included in the query 110. For example, the input features may be features extracted from the query 110 or the one or more words included in the query 110, and/or distribution information (e.g., appearance frequency or distribution probability) about each of a plurality of categories of the one or more words included in the query 110 or features of the one or more words calculated based on such distribution information.

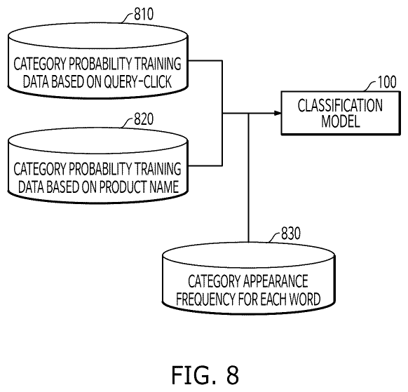

According to an embodiment, the classification model 100 may be trained based on a training data set about various product queries, such as information on whether a user selects the product search result for the query (e.g., information on the number of clicks of a user for the product search result for the query) and product information (e.g., product names or words included in the product names), the product search results, or the category probability or distribution of the products or query words. A training method for the classification model 100 will be described later with reference to FIGS. 8 to 12.

The classification model 100 that is trained based on the training data set as described above may be configured so that a relatively high score is given to the product category having a large number of appearances (or high appearance frequency) of one or more words included in the query 110 or having a high appearance probability thereof. In some embodiments, the classification model 100 may be configured so that a relatively low score is given to the product category having a low appearance frequency of one or more words included in the query 110 or having a low appearance probability thereof. Accordingly, even if a query including a word having a relatively low search frequency is received in the classification model 100, but the corresponding word has a high appearance frequency/appearance probability in a specific product category, a product category-related score in proportion to the appearance frequency/appearance probability may be output with respect to the corresponding category. Accordingly, even if a query related to a newly registered product or a query including a word having a low search frequency is received, the classification model 100 may properly calculate and output a category-related score related to the product. As exemplified in FIG. 1, if the query 100 or input features obtained from the query 110 is input to the classification model 100 in the case that a user inputs the query 110 in a search window of a shopping site, related probabilities or scores 120 for a plurality of product categories may be output from the classification model 100.

Further, the search result 130 for the query may be output from the user terminal through reflection of the related probability or score 120 for each of the plurality of product categories therein. The search result 130 may include images or names representing the searched products and the product categories.

In FIG. 1, it may be exemplified that if a “one-piece dress,” for example, is input as the query 110, a clothing product (“one-piece dress 1”) related to the category “women's clothing” is output as the search result 130, and a game product (“game 1”) related to the category “game title” is output. According to an embodiment, after a plurality of products related to the query are searched for from a product database, the search ranking of the products that are displayed in a search result area may be adjusted based on the related scores of the plurality of product categories that are output from the classification model 100. In FIG. 1, it may be exemplified that among various products extracted from the product database, “one-piece dress 1” of the women's clothing and “game 1” of the game title are first displayed as the search result. For example, the “one-piece dress 1” having the highest score calculated for the category “women's clothing” may be displayed at the uppermost end of the search result, and the “game 1” having the second highest score calculated for the game title category may be displayed in the next order.

A user may be able to easily and quickly check the products included in the product category that is highly relevant to the query 110 through the search result 130. Further, as needed, a user may obtain more detailed information about the selected product or may make an online purchase of the selected product by selecting or clicking any one of the corresponding products.

For example, the product search result for the query 110 may be obtained from the product database. The product search result 130 may include plural pieces of product data. Here, the product data may include a product image, a product name, a product price, seller information, product details, link to product details view, and a product category. The product search for the query may be executed by extracting plural pieces of product data that are highly relevant to the query among the product data stored in the product database. In the product search result 130 extracted as above, the product data highly relevant to the query 110 may be displayed above the product data lowly relevant to the query 110. Further, the product search rankings in accordance with the product search result may be adjusted based on the calculated related score of the product category for the query 110. For example, in the case where the query 110 is the “one-piece dress,” and the related score of the category “women's clothing” is highest, the product data that belongs to the category “women's clothing” may be displayed at towards the top of product search result 130.

According to an embodiment, the related probability or score 120 of the product category may be a predicted probability value where the query 110 is to be related to a specific product category. In FIG. 1, it is exemplified that if the query 110 includes the “one-piece dress,” the related score of the category “women's clothing” included in category 1 is “0.9,” the related score of the category “game title” included in category 2 is “0.4,” and the related score of the category “figure” included in category 3 is “0.2”. In this case, the product data that belongs to the category “women's clothing” may be displayed at the uppermost end of the search result 130.

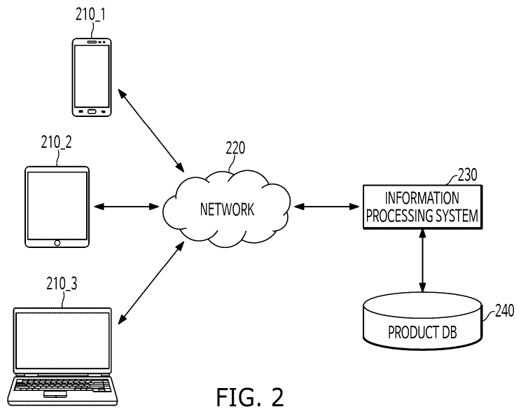

FIG. 2 is a schematic diagram illustrating a configuration that is communicably connected between an information processing system 230 and a plurality of user terminals 210_1, 210_2, 210_3 according to an embodiment of the present disclosure. As illustrated in FIG. 2, the plurality of user terminals 210_1, 210_2, 210_3 may communicate with the information processing system 230 through a network 220. According to an embodiment, the information processing system 230 may be a system for providing a product search service. The information processing system 230 may be connected to a product database (DB) 240 that stores and manages a training data set for training the classification model in order to provide the product search service, the frequency for each category of a query word, and product data that is provided as the product search result.

The network 220 may be configured so that communication between the plurality of user terminals 210_1, 210_2, 210_3 and the information processing system 230 is possible. Depending on the installation environment, the network 220 may be composed of, for example, a wired network 220, such as Ethernet, wired home network (power line communication), telephone line communication device, and RS-serial communication, a wireless network 220, such as mobile communication network, wireless LAN (WLAN), Wi-Fi, Bluetooth, and ZigBee, or a combination thereof. The communication method may not be limited, and may include not only the communication method that utilizes a communication network (e.g., mobile communication network, wired Internet, wireless Internet, broadcasting network, and satellite network) that can be included in the network 220 but also the near field communication among the user terminals 210_1, 210_2, 210_3. For example, the network 220 may include one or more random networks among a personal area network (PAN), a local area network (LAN), a campus area network, a metropolitan area network (MAN), a wide area network (WAN), a broadband network (BBN), and the Internet. Further, the network 220 may include one or more network topologies including a bus network, a star network, a ring network, a mesh network, a star-bus network, and a tree or hierarchical network, but is not limited thereto.

In an embodiment, the information processing system 230 may include one or more server devices which can store, provide, and execute a computer-executable program (e.g., downloadable application) and data that are related to the product search service or the like and/or a database, or one or more distributed computing devices based a clouding computing service and/or a distributed database. The information processing system 230 may perform pre-training of the classification model. According to an embodiment, the information processing system 230 may train the classification model 100 based on the training data set about various product queries, such as information on whether a user selects the product search result for the query and product information (e.g., product names), the search result, or the category distribution of the products or query words.

The information processing system 230 may provide the product search service by using a search engine or the like. According to an embodiment, the information processing system 230 may access the product database 240 in order to search for a plurality of products related to the query. Here, the product database 240 may store plural pieces of product metadata therein. According to some embodiments, some of the product data may be set as representative product data. Here, the representative product data may be product data that is determined to have frequent exposure due to an advertising policy or the like. Further, the information processing system 230 may generate the training data set that is used for the model training by accessing a search log database (not illustrated in the drawing) that includes the query input by the user and the product data selected by the user.

According to an embodiment, the information processing system 230 may receive the query related to the search from each of the plurality of user terminals 210_1, 210_2, 210_3. For example, the information processing system 230 may receive a query which is input to a search engine of a search site that is displayed by a web browser, a query which is input to a search engine of a search site that is displayed by a mobile browser application, or a query which is input to a search engine of a shopping site that sells products.

According to an embodiment, the information processing system 230 may obtain related scores of a plurality of product categories for the query by applying input features obtained from the query to the classification model. In an embodiment, the information processing system 230 may include the classification model configured to calculate the related score of the product category. The information processing system 230 may extract a product category having high probability (i.e., related score) to be related to one or more words included in the query among the plurality of product categories, and may search for the product data that belongs to the corresponding product category from the product database. The ranking of the product data searched as above may be readjusted based on the related score of the product category.

According to an embodiment, each of the plurality of user terminals 210_1, 210_2 210_3 may transmit the query related to the product search to the information processing system 230, and may receive and output question and answer data including the search result.

In FIG. 2, although a cellular phone terminal 210_1, a tablet terminal 210_2, and a PC terminal 210_3 are illustrated as examples of user terminals, the user terminals are not limited thereto, and the user terminal 210_1, 210_2, 210_3 may be any computing device in which wired and/or wireless communication are possible and an application or a web browser is installed to be able to be executed. For example, the user terminal may include a smartphone, a cellular phone, navigation, a computer, a notebook computer, a digital broadcasting terminal, personal digital assistants )PDA), a portable multimedia player (PWM), a tablet PC, a game console, a wearable device, an Internet of things (IoT) device, a virtual reality (VR) device, an augmented reality (AR) device, or a set-top box. Further, in FIG. 2, although it is illustrated that three user terminals 210_1, 210_2, 210_3 communicate with the information processing system 230 through the network 220, the number of user terminals is not limited thereto, and a different number of user terminals may be configured to communicate with the information processing system 230 through the network 220.

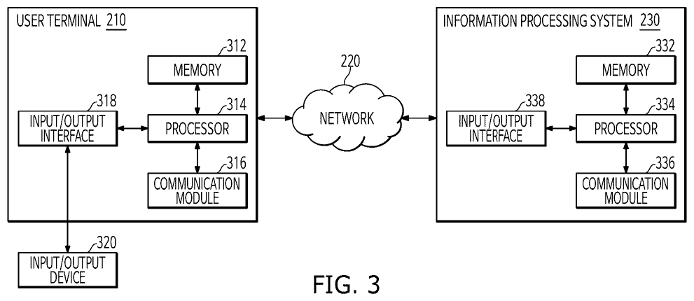

FIG. 3 is a block diagram illustrating an internal configuration of a user terminal 210 and an information processing system 230 according to an embodiment of the present disclosure. The user terminal 210 may be referred to as any computing device in which wired/wireless communication is possible, and may include, for example, a cellular phone or a smartphone 210_1 of FIG. 2, a tablet computer 210_2, and a lap-top or desk-top computer 210_3. As illustrated, the user terminal 210 may include a memory 312, a processor 314, a communication module 316, and an input/output interface 318. Similarly, the information processing system 230 may include a memory 332, a processor 334, a communication module 336, and an input/output interface 338. As illustrated in FIG. 3, the user terminal 210 and the information processing system 230 may be configured to communicate information and/or data through the network by using the communication modules 316 and 336, respectively. Further, the input/output device 320 may be configured to input information and/or data to the user terminal 210 or to output information and/or data generated from the user terminal 210 through the input/output interface 318.

The memory 312 or 332 may include any non-transitory computer-readable recording medium. According to an embodiment, the memory 312 or 332 may include a permanent mass storage device, such as read only memory (ROM), disk drive, solid state drive (SSD), or flash memory. As another example, the permanent mass storage device, such as the ROM, SSD, flash memory, or disk drive, may be a separate permanent storage device that is distinct from the memory, and may be included in the user terminal 210 or the information processing system 230. Further, the memory 312 or 332 may store an operating system and at least one program code (e.g., code related to a product search service).

Such software components may be loaded from a computer-readable recording medium separate from the memory 312 or 332. Such a separate computer-readable recording medium may include a recording medium that is directly connectable to the user terminal 210 or the information processing system 230, and may include, for example, a computer-readable recording medium, such as floppy drive, disk, tape, DVD/CD-ROM drive, or memory card. As another example, software components may be loaded onto the memory 312 or 332 through a communication module other than a computer-readable recording medium. For example, at least one program may be loaded onto the memory 312 or 332 based on a computer program (e.g., program for product search) installed by files provided through the network 220 by developers or a file distribution system that distributes installation files for applications.

The processor 314 or 334 may be configured to process instructions of a computer program by performing basic arithmetic, logic, and input/output operations. These instructions may be provided to the processor 314 or 334 by the memory 312 or 332 or the communication module 316 or 336. For example, the processor 314 or 334 may be configured to execute received instructions in accordance with a program code stored in a recording device, such as the memory 312 or 332.

The communication modules 316 or 336 may provide a configuration or function for the user terminal 210 and the information processing system 230 to communicate with each other through the network 220, and may provide a configuration or function for the user terminal 210 and/or the information processing system 230 to communicate with other user terminals or other systems (e.g., separate cloud system). As an example, a request (e.g., product search request) that is generated by the processor 314 of the user terminal 210 in accordance with a program code stored in a recording device, such as the memory 312, may be transmitted through the network 220 to the information processing system 230 under the control of the communication module 316. In reverse, a control signal or command provided under the control of the processor 334 of the information processing system 230 may be transmitted through the communication module 336 and the network 220 and received by the user terminal 210 through the communication module 316 of the user terminal 210.

The input/output interface 318 may be a means for interfacing with the input/output device 320. As an example, an input device of the input/output device 320 may include a device, such as a camera including a keyboard, a microphone, a mouse, and an image sensor, and an output device of the input/output device 320 may include a device, such as a display, a speaker, and a haptic feedback device. As another example, the input/output interface 318 may be a means for interfacing with a device of which the configurations or functions for performing an input and output are integrated into one, such as a touchscreen. For example, when the processor 314 of the user terminal 210 processes instructions of a computer program loaded onto the memory 312, a service screen that is configured by using information and/or data provided by the information processing system 230 or another user terminal may be displayed on a display through the input/output interface 318.

In FIG. 3, the input/output device 320 is illustrated as not being included in the user terminal 210, but is not limited thereto, and the input/output device 320 may be configured to be integrated with the user terminal 210. Further, the input/output interface 338 of the information processing system 230 may be a way for interfacing with a device (not illustrated) for input or output that is capable of being connected to or included in the information processing system 230. In FIG. 3, the input/output interface 318 or 338 is illustrated as being configured separately from the processor 314 or 334, but is not limited thereto, and the input/output interface 318 or 338 may be configured to be included in the processor 314 or 334.

The user terminal 210 or the information processing system 230 may include more components than those shown in FIG. 3. According to an embodiment, the user terminal 210 may be implemented to include at least some of the input/output devices 320 described above. Further, the user terminal 210 may further include other components, such as a transceiver, a global positioning system (GPS) module, a camera, various sensors, and a database.

The processor 334 of the information processing system 230 may be configured to manage, process, and/or store information and/or data received from a plurality of user terminals including the user terminal 210 and/or a plurality of external systems. The information and/or data processed by the processor 334 may be provided to the user terminal 210 through the communication module 336. In an embodiment, the processor 334 may receive the query related to the product search, extract the product search result for the query from the product database, and execute instructions for obtaining related scores of a plurality of product categories by inputting the query or one or more words included in the query to the classification model. In some embodiments, the processor 334 may execute instructions for adjusting the product search ranking in accordance with the product search result based on the obtained related score.

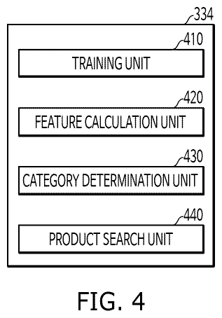

FIG. 4 is a block diagram illustrating an internal configuration of a processor of an information processing system according to an embodiment of the present disclosure. As illustrated, the processor 334 of the information processing system 230 may include a training unit 410, a feature calculation unit 420, a category determination unit 430, and a product search unit 440. The classification model 100 according to an embodiment of the present disclosure may be configured to include the feature calculation unit 420 and the category determination unit 430.

The training unit 410 may train the classification model 100 to calculate related scores or probabilities for a plurality of categories through the query input. According to an embodiment, the training unit 410 may train the classification model 100 based on a training data set including training data about the category probability based on information (e.g., query-click information) on whether a user selects the product search result for the query, and/or training data about the category probability based on the product information (e.g., product name). A method in which the training unit 410 trains the classification model 100 will be described later with reference to FIGS. 8 to 12.

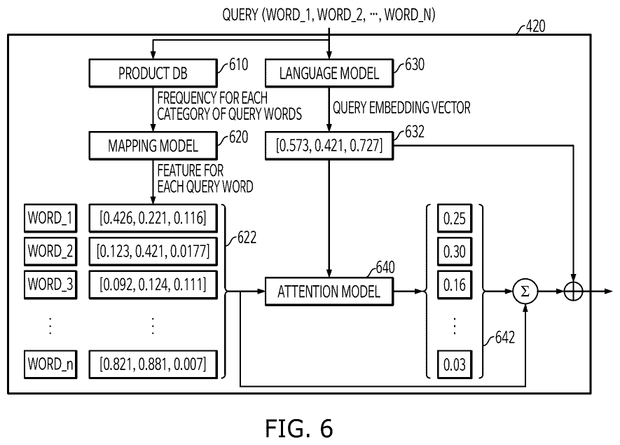

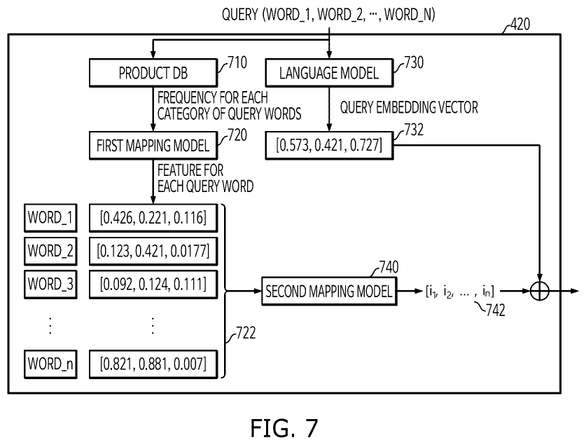

The feature calculation unit 420 may calculate input features from the query. According to an embodiment, the input features may be features extracted from the query or one or more words included in the query, and/or distribution information (e.g., appearance frequency or distribution probability) of each of a plurality of categories of one or more words included in the query, or features of one or more words calculated based on the distribution information. A method in which the feature calculation unit 420 calculates the input features from the query will be described later with reference to FIGS. 6 and 7.

The category determination unit 430 may calculate the related scores or probabilities of a plurality of categories for the corresponding query based on the input features calculated from the query by the feature calculation unit 420. Further, the category determination unit 430 may determine one or more categories related to the query based on the calculated related scores or probabilities of the plurality of categories. For example, the category determination unit 430 may determine the category having the predetermined number of uppermost related scores or probabilities as the category related to the query.

The product search unit 440 may generate the product search result for the query based on the related scores or probabilities of the plurality of categories calculated by the category determination unit 430. In an embodiment, the product search unit 440 may obtain the product search result that corresponds to the query from the product database. The product search result may include plural pieces of product data. The product search unit 440 may generate the product search result by extracting plural pieces of product data that are highly relevant to the query among the product data stored in the product database. In the product search result generated as above, the product data highly relevant to the query may be displayed above the product data that is less relevant to the query. Further, the product search unit 440 may adjust the product search rankings in accordance with the product search result based on the related scores of the product categories for the query, which are calculated by the category determination unit 430.

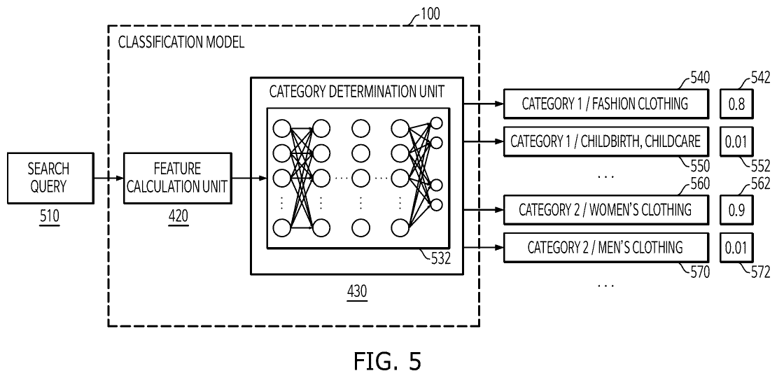

FIG. 5 is a diagram exemplifying a configuration in which the classification model 100 including the feature calculation unit 420 and the category determination unit 430 calculates category-related scores from a query according to an embodiment of the present disclosure.

The feature calculation unit 420 may obtain the input features from a search query 510. The feature calculation unit 420 may obtain the input features based on the query 510, and may input the input features to the category determination unit 430. In an embodiment, the input features may include features of the query 510 or one or more words included in the query 510. For example, the features of the query or word may be a query embedding vector extracted from the query or one or more words included in the query by a language model. In some embodiments, the input features may be the result of reflecting the importance of each query word in the features for each query word that is extracted based on the appearance frequency for each category of one or more words (or query words) included in the query 510. For example, the importance for each query word may be a feature vector calculated by inputting the query embedding vector extracted by the language model and the features for each query word to an attention model based on decoder-encoder architecture. In various embodiments, the attention model may be at least a part of a deep learning model used for natural language processing and may output the feature vector indicating the importance for each query word by evaluating how important each element of input data (e.g., the query embedding vector and the features for each query word) is to the output based on an attention mechanism.

The category determination unit 430 may calculate and output related scores 542, 552, 562, 572 for a plurality of product categories 540, 550, 560, 570 by inputting the input features calculated by the feature calculation unit 420 to a category model 532. The category model 532 may be configured as a deep learning model so as to output the high related score of the product category that is relevant to the word having high importance among one or more words included in the query 510.

FIG. 6 is a block diagram illustrating an internal configuration of the feature calculation unit 420 according to an embodiment of the present disclosure. As illustrated, if a search query including one or more words word_1 to word_n is input, the feature calculation unit 420 may extract the frequency for each category of the query words word_1 to word_n. In an embodiment, the feature calculation unit 420 may extract the frequency for each category of the query words word_1 to word_n stored in a product database 610. Here, the product database 610 may extract and store the appearance frequency or distribution information of each query word in a plurality of categories based on, for example, product data or a product name included in the product metadata and corresponding product category information. In another embodiment, the feature calculation unit 420 may extract the frequency for each category of each word in which two or more of the query words word_1 to word_n are combined. In this case, the product database 610 may extract and store the appearance frequency or distribution information of each word, in which two or more of the query words are combined, in a plurality of categories based on, for example, product data or a product name included in the product metadata and corresponding product category information.

Further, the feature calculation unit 420 may calculate a feature 622 for each query word based on the frequency for each category of the query words extracted from the product database 610 by using a mapping model 620. In an embodiment, the mapping model 620 may determine m (e.g., m=4) words having the lowermost frequency value among the frequency values by categories of the query words. Further, the mapping model 620 may calculate an output vector in which the degree of a vector representing the frequency value for each category of the determined m words is reduced as the feature 622 for each query word.

In some embodiments, the feature calculation unit 420 may calculate a query embedding vector 632 by inputting the query to a language model 630 (e.g., BERT model). Further, the feature calculation unit 420 may calculate an importance 642 for each query word by inputting the feature 622 for each query word to an attention model 640 as a key value, and inputting the query embedding vector 632 as the query. The importance 642 for each query word may be summed by weight to the feature 622 for each query word. The feature 622 for each query word to which the importance 642 for each query word is summed by weight may be concatenated with the query embedding vector 632, and may be provided to the category determination unit or the category model. In various embodiments, the importance 642 for each query word may mean a relative level indicating how important each of one or more words included in the query is referenced when determining the category associated with the query.

FIG. 7 is a block diagram illustrating an internal configuration of the feature calculation unit 420 according to another embodiment of the present disclosure. As illustrated, if a search query including one or more words word_1 to word_n is input, the feature calculation unit 420 may extract the frequency for each category of the query words word_1 to word_n. In an embodiment, the feature calculation unit 420 may extract the frequency for each category of the query words word_1 to word_n stored in a product database 710. Here, the product database 710 may extract and store the appearance frequency or distribution information of each query word in a plurality of categories based on, for example, product data or a product name included in the product metadata and corresponding product category information. In another embodiment, the feature calculation unit 420 may extract the frequency for each category of each word in which two or more of the query words word_1 to word_n are combined.

Further, the feature calculation unit 420 may calculate a feature 722 for each query word based on the frequency for each category of the query words extracted from the product database 710 by using a first mapping model 720. In an embodiment, the first mapping model 720 may calculate a vector that represents an average value of the frequency for each category of the query words. Further, the feature calculation unit 420 may calculate an output vector in which the degree of the vector representing the average value of the frequency for each category of the query words is reduced by using a second mapping model 740 as a feature 742 for each query word.

In some embodiments, the feature calculation unit 420 may calculate a query embedding vector 732 by inputting the query to a language model 730 (e.g., BERT model). The feature 742 for each query word may be concatenated with the query embedding vector 732, and may be provided to the category determination unit 430 or the category model 532.

FIG. 8 is a diagram illustrating a training procedure of the classification model 100 according to an embodiment of the present disclosure. The classification model 100 may include the feature calculation unit 420 and the category determination unit 430 as described above with reference to FIGS. 4 to 7. The classification model 100 may be trained based on a training data set about various product queries, such as information on whether a user selects the product search result for the query (e.g., query-click information) and product information (e.g., product names), the search results, or the category probability or distribution of the products or query words.

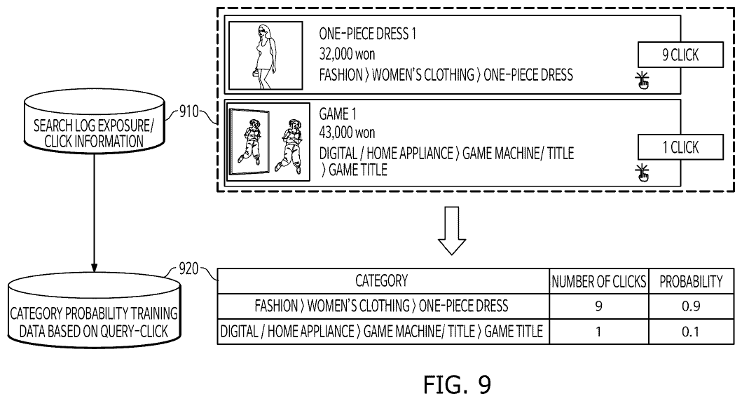

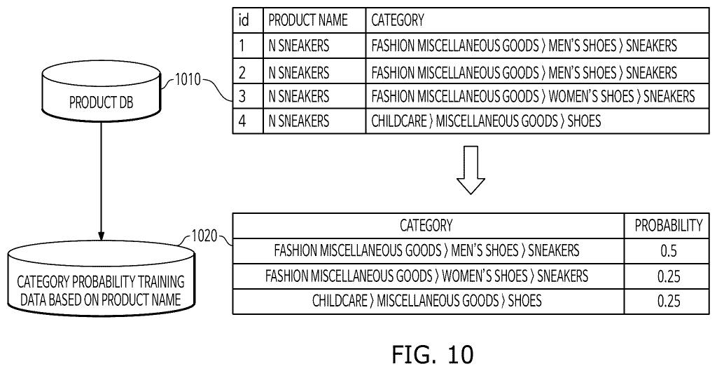

According to an embodiment, the classification model 100 may be trained based on category probability training data 810 based on the query-click and category probability training data 820 based on the product name. Here, the category probability training data 810 based on the query-click may be extracted from a search log (e.g., exposure/click information) for the product query. Further, the category probability training data 820 based on the product name may be extracted from product category information corresponding to a plurality of product names stored in a product database. A method for extracting or generating the training data 810 or 820 will be described later with reference to FIGS. 9 and 10.

Further, in a process in which the classification model 100 is trained based on the category probability training data 810 based on the query-click and the category probability training data 820 based on the product name, the classification model 100 may use the category appearance frequency 830 for each word. In an embodiment, in the process in which the classification model 100 is trained based on the training data 810 or 820, the classification model 100 may extract the feature for each query word based on the category appearance frequency 830 for each word. For example, a method that is the same as or similar to the case where the feature calculation unit 420 extracts the feature for each query word based on the category appearance frequency for each word as described above with reference to FIGS. 6 and 7 may be applied to the training process of the classification model 100.

As described above, because the feature for each query word that is extracted based on the category appearance frequency 830 for each word is used in the process in which the classification model 100 is trained by using the training data 810 or 820, the classification model 100 may be configured so that a relatively high score is given to the product category having a large number of appearances (or high appearance frequency) of one or more words included in the query or having a high appearance probability thereof. Accordingly, even if a query including a word having a relatively low search frequency is received in the classification model 100, but the corresponding word has a high appearance frequency/appearance probability in a specific product category, a product category-related score in proportion to the appearance frequency/appearance probability may be output with respect to the corresponding category. Accordingly, even if a query related to a newly registered product or a query including a word having a low search frequency is received, the classification model 100 may properly calculate and output a category-related score related to the product.

FIG. 9 is a diagram illustrating a procedure of generating category probability training data based on user selection information on the product search result corresponding to a search query according to an embodiment of the present disclosure. As illustrated, category probability training data 920 based on the query-click may be extracted from search log exposure/click information 910. That is, the category probability training data 920 based on the query-click may be generated based on whether a user selects (clicks) the product search result for the product query or the number of selections.

In an embodiment, whether the user selects (e.g., clicks) the product search result for the product query or the number of selections may be determined by analyzing the search log exposure/click information 910 from the database in which a product search history is stored. For example, as the result of analyzing the search log exposure/click information 910, in the case that the user clicks the product “one-piece dress 1” nine times, but the user clicks the product “game 1” once among the product search results for the query, it may be possible to generate category probability values of 0.9 and 0.1 with respect to “fashion clothing>women's clothing>one-piece dress” and “digital home appliance>game machine>title>game title,” respectively, which are categories to which the corresponding products belong in proportion to the number of user's clicks for each of the products. The category probability values generated as above may be stored as the category probability training data 920 based on the query-click, and may be used for training of the classification model 100.

FIG. 10 is a diagram illustrating a procedure of generating category probability training data based on product names according to an embodiment of the present disclosure. As illustrated, category probability training data 1020 based on product names may be extracted from a product database 1010. That is, the category probability training data 1020 based on the product names may be generated based on respective appearance frequencies of a plurality of product names in a plurality of categories.

In one embodiment, the number of appearances or appearance probability for each category to which respective product names belong may be determined by analyzing the product database 1010. For example, as the result of analyzing the product database 1010, it may be checked that the product name “N sneakers” appears twice in the category “fashion miscellaneous goods>men's shoes>sneakers,” appears once in the category “fashion miscellaneous goods>women's shoes>sneakers,” and appears once in the category “childcare>miscellaneous goods>sneakers.” In this case, the respective category probability values may be calculated as 0.5, 0.25, and 0.25 based on the number of appearances of the corresponding product in the three categories. The category probability values calculated as above may be stored as the category probability training data 1020 based on the product names, and may be used for the training of the classification model 100.

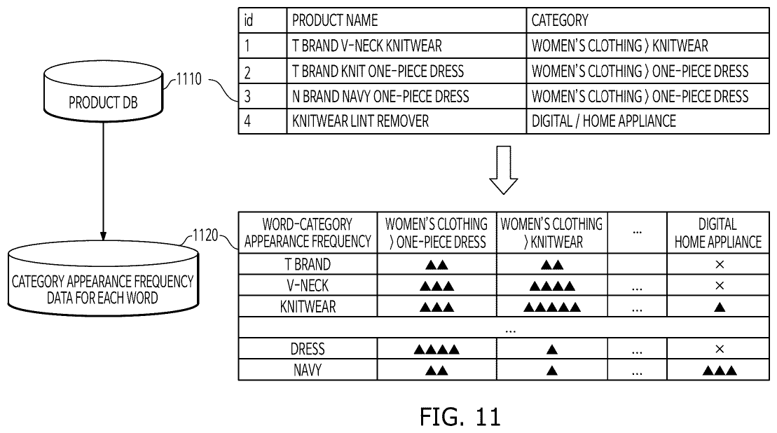

FIG. 11 is a diagram illustrating a procedure of generating category appearance frequency data for each word according to an embodiment of the present disclosure. As illustrated, category appearance frequency data 1120 for each word may be extracted from a product database 1110. That is, the category appearance frequency data 1120 for each word may be generated based on respective appearance frequencies of a plurality of words included in a plurality of product names in a plurality of categories.

In one embodiment, the number of appearances for each category where a plurality of words included in the product names belong or appear may be determined by analyzing the product database 1110. For example, as the result of analyzing the product database 1110, it may be checked that the product name “T brand V-neck knitwear” appears in the category “women's clothing>knitwear,” the product names “T brand knitwear one-piece dress” and “N brand navy one-piece dress” appear in the category “women's clothing>one-piece dress,” and the product name “knitwear lint remover” appears in the category “digital>home appliances.” In this case, based on the number of appearances of each of “T brand,” “V-neck,” “knitwear,” “dress,” and “navy,” which are the plurality of words included in the plurality of product names, in three categories, the respective category frequency values may be calculated. The category frequency values calculated as above may be stored as the category appearance frequency data 1120, and may be used to extract the input features for the query in the training process of the classification model 100. Further, the category appearance frequency values for each word may be referred to by the feature calculation unit 420, and may be used to extract the input features for the query.

FIG. 11 illustrates a process of calculating the category appearance frequency for each of a plurality of words included in a plurality of product names, but the illustrated process is not limited thereto. For example, the category appearance frequency for each of a word in which two or more of words included in a plurality of product names are combined may also be calculated. For example, based on the appearance frequency information of the category appearance frequency data 1120 for each word, the appearance frequency for each of the plurality of categories for “T brand V-neck” in which “T brand” and “V-neck” are combined may be additionally calculated.

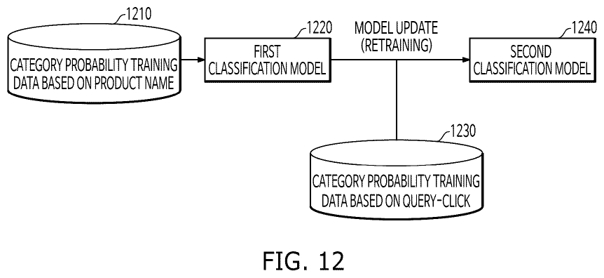

FIG. 12 is a diagram illustrating a training procedure of two classification models 100 according to an embodiment of the present disclosure. A first classification model 1220 and a second classification 1240 are each identical to the classification model 100 described above. The first classification model 1220 and the second classification model 1240 may both be trained based on a training data set about the category probability or distribution of information on whether a user selects the product search result for the query (e.g., query-click information) and product information (e.g., product names).

According to an embodiment, the first classification model 1220 may be trained based on category probability training data 1210 based on the product name. Here, the category probability training data 1210 based on the product name may be extracted from product category information corresponding to a plurality of product names stored in the product database. For example, the training data 1210 may be extracted by using the method illustrated in FIG. 10.

In another embodiment, the first classification model 1220 may be retrained based on the category probability training data 1230 based on the query and information on the number of clicks of the user for the product search result provided according to the query, and may be updated onto the second classification model 1240. Here, the category probability training data 1230 based on the query-click may be extracted from a search log (e.g., exposure/click information) for the product query. For example, the training data 1230 may be extracted by using the method illustrated in FIG. 9.

The second classification model 1240 trained using the training data 1230 and the training data 1210 may be configured so that a relatively high score is given to the product category having a large number of appearances (or high appearance frequency) of one or more words included in the query or having a high appearance probability thereof. Accordingly, even if a query including a word or a product name having a relatively low search frequency is received in the second classification model 1240, but the corresponding word or product name has a high appearance frequency/appearance probability in a specific product category, a product category-related score in proportion to the appearance frequency/appearance probability may be output with respect to the corresponding category. Accordingly, even if a query related to a newly registered product or a query including a word or product name having a low search frequency is received, the second classification model 1240 may properly calculate and output a category-related score related to the product.

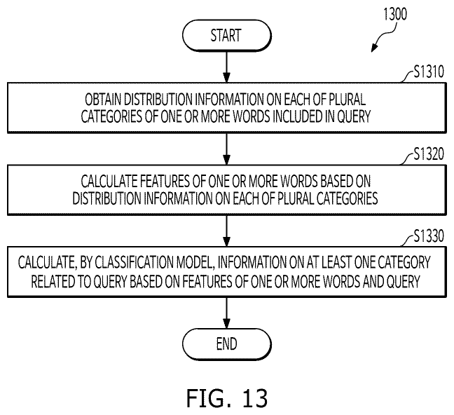

FIG. 13 is a flowchart explaining a method for determining categories for a search query according to an embodiment of the present disclosure. According to an embodiment, a method 1300 for determining categories for the query may be executed by the processor 334 of the information processing system 230. The method 1300 for determining categories for the query may begin with obtaining distribution information for a plurality of categories of one or more words included in the query (S1310).

In an embodiment, obtaining the distribution information for a plurality of categories of one or more words included in the query (S1310) may include obtaining probability information that is calculated based on the appearance frequency of one or more words in the plurality of categories in plural pieces of product data.

In another embodiment, obtaining the distribution information for a plurality of categories of one or more words included in the query (S1310) may include calculating distribution information on each of the plurality of categories for each word of one or more words or each word in which two or more of the one or more words are combined. In this case, in calculating features of the one or more words based on the distribution information on each of the plurality of categories, the features of the one or more words may be calculated based on the distribution information on each of the plurality of categories for each word of the one or more words or each word in which two or more of the one or more words are combined.

The method 1300 may further include calculating the features of the one or more words based on the distribution information on each of the plurality of categories (S1320).

In an embodiment, calculating the features of the one or more words (S1320) may include calculating importance of the one or more words based on the distribution information on each of the plurality of categories and the features of the query; and calculating the features of the one or more words by applying the importance to the distribution information on each of the plurality of categories as a weight. Further, calculating the importance of the one or more words may include calculating the feature of each of the one or more words based on the distribution information on each of the plurality of categories; calculating, by a language model, the features of the query; and calculating, by an attention model, the importance of the one or more words based on the features of the one or more words and the features of the query.

In another embodiment, calculating the features of the one or more words (S1320) may include selecting a predetermined number of words from the one or more words based on the number of categories in which each of the one or more words appears in plural pieces of product data; calculating the importance of each of the selected words based on the distribution information on each of the plurality of categories of the selected words and the features of the query; and calculating the features of the selected words by applying the importance to the distribution information on each of the plurality of categories as a weight.

In still another embodiment, calculating the features of the one or more words (S1320) may include calculating an average value of the category appearance frequencies related to each of the one or more words based on the appearance frequency of the one or more words in each of the plurality of categories in the plural pieces of product data; and obtaining the features of the one or more words based on the calculated average value.

The method 1300 may further include calculating, by the classification model, information on at least one category related to the query based on the features of the one or more words and the query (S1330). In some embodiments, the method 1300 may further include adjusting ranking information of the product search result for the query based on the calculated information on the at least one category.

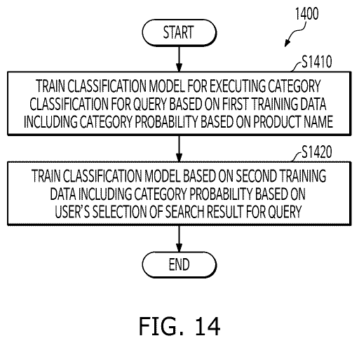

FIG. 14 is a flowchart explaining a training method of a classification model for a search query according to an embodiment of the present disclosure. According to an embodiment, a training method 1400 of the classification model 100 for the query may be executed by the processor 334 of the information processing system 230. The training method 1400 of the classification model for the query may begin with training the classification model for executing a category classification for the query (S1410) based on first training data including a category probability based on a product name. Here, the first training data may be generated based on a probability of each of a plurality of product names being included in product meta information related to a plurality of categories.

Further, the method 1400 may further include training the classification model based on second training data including the category probability based on a user's selection of the search result for the query (S1420). Here, the second training data may be generated based on a category probability of the product selected by a user among the search results for a plurality of queries.

The above-described steps (S1410 and S1420) may proceed simultaneously or sequentially. In an embodiment, the classification model 100 may be trained by using the first training data and the second training data together. In another embodiment, the classification model 100 may be trained by using the first training data, and then may be retrained by using the second training data.

Further, in the process in which the classification model 100 is trained based on the first training data and the second training data, the category appearance frequency for each word may be used. That is, in the process in which the classification model 100 is trained based on the first and second training data, the feature for each query word may be extracted based on the category appearance frequency for each word. In an embodiment, at least one of the steps (S1410 or S1420) may include obtaining distribution information on each of a plurality of categories of the one or more words included in the query; calculating the features of the one or more words based on the distribution information on each of the plurality of categories; and calculating, by the classification model, the probability for the at least one category related to the query based on the features of the one or more words and the query.

The above-described method may be provided as a computer program stored in a computer-readable recording medium for execution on a computer. Recording media may be used to continuously store programs executable on a computer or to temporarily store them for execution or download. Further, the media may be a variety of recording or storage means in the form of a single piece of hardware or a combination of several pieces of hardware, and the media may be directly connected to a certain computer system or may be distributed over a network. Examples of the media may include magnetic media such as hard disk, floppy disk and magnetic tape, optical recording media such as CD-ROM and DVD, magneto-optical media such as floptical disk, ROM, RAM, and flash memory, which may be configured to store program instructions. Further, examples of other media may include recording or storage media managed by app stores that distribute applications, or by sites or servers that supply or distribute various other pieces of software.

The methods, operations, or techniques of the present disclosure may be implemented by various means. For example, such techniques may be implemented in hardware, firmware, software, or a combination thereof. Those skilled in the art will understand that the various illustrative logical blocks, modules, circuits, and algorithm steps described in connection with the present disclosure may be implemented in electronic hardware, computer software, or a combination thereof. To clearly illustrate this mutual replacement between the hardware and software, various illustrative components, blocks, modules, circuits, and steps have been described above generally in terms of their functionality. Whether such functionality is implemented in hardware or software depends on specific applications and design requirements imposed on the overall system. Those skilled in the art may implement the described functionality in various ways for the specific applications, but such implementations should not be construed as departing from the scope of the present disclosure.

In hardware implementation, the processing units used to perform the techniques may be implemented with one or more ASICs, DSPs, digital signal processing devices (DSPDs), programmable logic devices (PLDs), field programmable gate arrays (FPGAs) s), processors, controllers, microcontrollers, microprocessors, electronic devices, other electronic units designed to perform the functions described in the present disclosure, computers, or a combination thereof.

Accordingly, the various exemplary logical blocks, modules, and circuits described in connection with the present disclosure may be implemented with or performed by processors, DSPs, ASICs, FPGAs, programmable logic devices, discrete gates, transistor logics, discrete hardware components, or any combination thereof designed to perform the functions described herein. A processor may be a microprocessor, but alternatively, the processor may be any processor, controller, microcontroller, or state machine. The processors may also be implemented as a combination of computing devices, such as a DSP and a microprocessor, a plurality of microprocessors, one or more microprocessors in conjunction with a DSP core, or any other configurations.

In firmware and/or software implementation, the techniques may be implemented as instructions stored in a computer-readable medium such as random access memory (RAM), read-only memory (ROM), nonvolatile random access memory (NVRAM), programmable read-only memory (PROM), erasable programmable read-only memory (EPROM), electrically erasable PROM (EEPROM), flash memory, compact disc (CD), or magnetic or optical data storage device. The instructions may be executable by one or more processors, and may cause the processor(s) to perform specific aspects of the functionality described in the present disclosure.

When implemented in software, the above-described techniques may be stored in or transmitted through computer-readable media as one or more instructions or codes. The computer-readable media include both computer storage media and communication media by including any media that facilitate the transfer of a computer program from one place to another. The storage media may be any available media that can be accessed by a computer. As non-limiting examples, these computer readable media may include RAM, ROM, EEPROM, CD-ROM or other optical disk storage, magnetic disk storage or other magnetic storage devices, or any other media that may be used to transport or store desired program codes in the form of instructions or data structures and may be accessed by a computer. Further, random accesses may be suitably made to computer-readable media.

For example, if software is transmitted from a website, server, or other remote source by using coaxial cable, fiber optic cable, twisted pair cable, digital subscriber line (DSL), or wireless technologies such as infrared rays, radio waves, and microwaves, these coaxial cable, fiber optic cable, twisted pair cable, digital subscriber line, or wireless technologies such as infrared rays, radio waves, and microwaves may be included in the definition of the media. As used herein, disks and discs include CD, laser disc, optical disc, digital versatile disc (DVD), floppy disk, and Blu-ray disc, where disks usually reproduce data magnetically, whereas discs reproduce data optically using lasers. Combinations thereof should also be included in the scope of the computer-readable media.

Software modules may be configured to reside in a RAM memory, flash memory, ROM memory, EPROM memory, EEPROM memory, registers, hard disk, removable disk, CD-ROM, or any other form of known storage medium. An exemplary storage medium may be coupled to a processor so that the processor may read information from or write information in the storage medium. Alternatively, the storage medium may be integrated into the processor. The processor and the storage medium may be present within an ASIC. The ASIC may be present in a user terminal. Alternatively, the processor and the storage medium may be present as separate components in the user terminal.

Although the above-described embodiments have been described as utilizing aspects of the subject matter disclosed herein on one or more standalone computer systems, the present disclosure is not limited thereto, and may also be implemented in conjunction with any computing environment such as a network or a distributed computing environment. Furthermore, aspects of the subject matter of the present disclosure may be implemented with a plurality of processing chips or devices, and storage may be similarly affected across the plurality of devices. These devices may include PCs, network servers, and portable devices.

Although the present disclosure has been described in relation to some embodiments in the specification, various modifications and changes may be made without departing from the scope of the present disclosure as can be understood by those skilled in the art to which the present disclosure pertains. Further, such modifications and changes should be considered to fall within the scope of the claims attached to the specification.

What is claimed is:

1. A method, performed by at least one processor, for determining categories for a search query, the method comprising:
obtaining distribution information on each of a plurality of categories of one or more words included in the search query;
calculating features of the one or more words based on the distribution information on each of the plurality of categories; and
calculating, by a classification model, information on at least one category related to the search query based on the features of the one or more words and the search query.

2. The method as claimed in claim 1, wherein the obtaining of the distribution information comprises:
obtaining probability information that is calculated based on an appearance frequency of the one or more words in each of the plurality of categories in plural pieces of product data.

3. The method as claimed in claim 1, wherein the calculating of the features of the one or more words comprises:
calculating an importance of the one or more words based on the distribution information on each of the plurality of categories and features of the search query; and
calculating the features of the one or more words by applying the importance to the distribution information on each of the plurality of categories as a weight.

4. The method as claimed in claim 3, wherein the calculating of the importance of the one or more words comprises:
calculating the feature of each of the one or more words based on the distribution information on each of the plurality of categories;
calculating, by a language model, the features of the search query; and
calculating, by an attention model, the importance of the one or more words based on the features of each of the one or more words and the features of the search query.

5. The method as claimed in claim 1, wherein the calculating of the features of the one or more words comprises:
selecting a predetermined number of words from the one or more words based on a number of categories in which each of the one or more words appears in plural pieces of product data;
calculating an importance of each of the selected words based on the distribution information on each of the plurality of categories of the selected words and the features of the search query; and
calculating features of the selected words by applying the importance of each of the selected words to the distribution information on each of the plurality of categories as a weight.

6. The method as claimed in claim 1, wherein the calculating of the features of the one or more words comprises:
calculating an average value of category appearance frequencies related to each of the one or more words based on an appearance frequency of the one or more words in each of the plurality of categories in plural pieces of product data; and
obtaining the features of the one or more words based on the calculated average value.

7. The method as claimed in claim 1, wherein the obtaining of the distribution information on each of a plurality of categories of the one or more words included in the search query comprises:
calculating the distribution information on each of the plurality of categories of each of the one or more words or each of the words in which two or more of the one or more words are combined, and
wherein the calculating of the features of the one or more words comprises calculating the features of the one or more words based on the distribution information on each of the plurality of categories of each of the one or more words or each of the words in which two or more of the one or more words are combined.

8. The method as claimed in claim 1, further comprising:
adjusting ranking information of a product search result for the search query based on a probability for the calculated at least one category.

9. A method, performed by at least one processor, for training a classification model for a search query, the method comprising:
training the classification model for executing a category classification for the search query based on first training data including a category probability based on product names; and
training the classification model based on second training data including a category probability based on a user's selection of a search result for the query.

10. The method as claimed in claim 9, wherein the training of the classification model for executing a category classification for the query comprises:
obtaining distribution information on each of a plurality of categories of one or more words included in the search query;
calculating features of the one or more words based on distribution information on each of the plurality of categories; and
calculating, by the classification model, a probability for at least one category related to the search query based on the features of the one or more words and the search query.

11. The method as claimed in claim 9, wherein the first training data is generated based on a probability of each of a plurality of product names being included in product meta information related to a plurality of categories.

12. The method as claimed in claim 9, wherein the second training data is generated based on a category probability of a product selected by a user among search results for a plurality of queries.

13. An information processing system comprising:
a memory; and
at least one processor connected to the memory and configured to execute at least one computer readable program included in the memory,
wherein the at least one program includes instructions to:
obtain distribution information on each of a plurality of categories of one or more words included in a search query,
calculate features of the one or more words based on the distribution information on each of the plurality of categories, and
calculate, by a classification model, information on at least one category related to the search query based on the features of the one or more words and the search query.
